(19) United States
(12) Patent Application Publication
(10) Pub. No.: US 2025/0068962 A1
(43) Pub. Date: Feb. 27, 2025

(54) PERFORMANCE EVALUATION OF ONLINE MACHINE LEARNING MODELS USING ANALYTICAL METRICS FOR SIBLING OFFLINE MACHINE LEARNING MODELS

(71) Applicant: Actimize LTD., Ra’anana (IL)

(72) Inventors: Yoav AVNEON, Ness-Ziyona (IL); Nitzan TAL, Modiin (IL); Danny BUTVINIK, Haifa (IL)

(21) Appl. No.: 18/454,591

(22) Filed: Aug. 23, 2023

(51) Int. Cl. G06N 20/00

(52) U.S. Cl. CPC G06N 20/00

(57) ABSTRACT

A machine learning (ML) system and methods are provided that are configured to provide a performance evaluation of an online ML model using an evaluation framework with an offline ML model. The system includes a processor and a computer readable medium operably coupled thereto, the computer readable medium comprising a plurality of instructions stored in association therewith that are accessible to, and executable by, the processor, to perform model comparison operations which include accessing, for a performance evaluation of a first ML model, a second ML model using the evaluation framework, determining a batch size for the performance evaluation, calculating first model scores for an analytical metric during an online run using the batch size, calculating decayed weights applied to the first model scores, comparing the first model scores with second model scores for the second ML model, and outputting the performance evaluation based on the comparing.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, such as those that may be used for fraud detection with financial institutions, and more specifically to a system and method for programmatically evaluating performance of online ML models using an evaluation framework and sibling offline models for performance and analytics metrics.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

AI and ML may provide cutting-edge solutions for various industries including those associated with intelligent decision-making, anomaly detection, and prediction. Specifically, one area where the application of AI and ML has gained considerable traction is in the domain of financial crime, where ML solutions are being increasingly adopted to counter fraudulent activities. For example, ML algorithms have been used for fraud detection, which has emerged as a frequent and beneficial use of ML models and systems for investigating and preventing fraud in financial systems. In comparison to a traditional fraud detection approach, ML-based approaches are a much more powerful and accurate method that can effectively address the scope and scale of modern production requirements.

Evaluating the performance of online machine learning models is important for their successful deployment and ongoing maintenance. However, there are unique issues and difficulties to evaluating online models that are learning incrementally, such as by continuously updating the models' knowledge based on incoming data streams. This further creates complexities in measuring and comparing online ML model performance to offline models, which may be key to providing the value of online ML models with real-world scenarios. These comparisons may assist with validating the effectiveness of the online ML models and providing insights into strengths and limitations. Additionally, compliance with service-level agreements (SLAs) and model governance requirements through evaluating ML model performance may ensure the model's reliability, fairness, and accountability.

For example, a service provider, such as a fraud detection system, may be required to meet stringent requirements of model governance and regulation while adhering to the principles of ethical AI including transparency, fairness, bias mitigation, and data privacy. However, with online ML models that continuously adapt and learn from streaming data, it may be required that the service provider establish their effectiveness and performance though comparisons to offline batch models trained on the same or similar amount, type, and/or set of data. The performance evaluation of online models becomes even more crucial for the service provider to deliver transparent, robust, and stable machine learning solutions. Presently, this is not possible without any effective measure of online ML models and thus no options to meet the requirements of model governance. Thus, it is desirable to address these inadequacies and challenges with evaluating the performance of online ML models. Therefore, there is a need to develop a system and framework for programmatically evaluating the performance of online ML models within the online ML paradigm context.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified diagram of a computing architecture to programmatically evaluate the performance of online ML models using sibling offline ML models trained and tested using batch datasets according to some embodiments.

FIG. 3 is a simplified diagram of a computing architecture including an ML modeling platform that may implement an online ML model through a development process that evaluates performance using a sibling offline ML model according to some embodiments.

FIG. 4 is a simplified diagram of ML operations used for performance evaluations of online ML models using comparisons of metrics and analytics with sibling offline ML models according to some embodiments.

FIG. 5 is a simplified diagram of an exemplary flowchart for determining and providing a performance evaluation of an online ML model using an evaluation framework with an offline ML model according to some embodiments.

FIG. 6 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In order to programmatically analyze, measure, and evaluate performance of online ML models, an ML model testing and evaluation framework may be utilized to provide performance evaluations of online ML models, such as using an offline ML model that acts, is trained, and/or is configured to be a sibling or corresponding model for predictive and decision-making purposes. The evaluation framework may be integrated with an ML system and/or model(s) that utilizes a set of training and testing data to create and select batch data sizes and batch datasets for model usage. ML models may be built on different tenants of a fraud detection and/or ML modeling system, such as different financial institutions, using historical or past activities, transactions, and/or other model training data. Fraud detection is a process that detects and prevents fraudsters from obtaining money or property through fraud. It is a set of activities undertaken to detect, inhibit, and preferably block the attempt of fraudsters to obtain money or property fraudulently. Fraud detection is prevalent across banking, insurance, medical, government, and public sectors, as well as law enforcement agencies. Fraudulent activities include money laundering, cyberattacks, fraudulent banking claims, forged bank checks, identity theft, and other illegal and/or malicious practices and conduct. As a result, organizations implement modern fraud detection and prevention technologies with risk management strategies to combat growing fraudulent transactions across diverse platforms.

Deploying AI for fraud prevention has helped companies enhance their internal security and streamline business processes. However, operationalization of AI in real systems and real-time fraud detection for financial fraud detection systems remains difficult, time consuming, and resource intensive. For example, ML operations and systems may utilize training and testing data with selected features, where validated models may be deployed to generate predictions, scores, decisions, or other outputs. The ML system may reduce the dependency on a human factor for fraud detection, where online ML models may be continuously learning, updating, and the like from live streams of data through incremental and/or online learning. This causes online ML models to be unique and difficult to evaluate at specific points in time since training is ongoing. Therefore, an evaluation framework may provide a systematic and formalized approach to compute empirical measurements and assess online ML model performance over time. By incorporating analytical and computational perspectives, the framework captures the nuances of online model behavior. The evaluation framework addresses the need to compare online models to their offline counterparts, which act as performance benchmarks.

In this regard, the evaluation framework for online ML models may address the challenges with proving the value of Online Incremental Learning (OIL) models and providing a comprehensive assessment of their performance over time. For example, the framework may provide empirical measures, such as the area under the curve (AUC), precision, and recall of the model's predictions, to determine predictive accuracy and classify performance of online ML models through comparisons to offline ML models. Additionally, computational aspects, such as memory and hardware requirements, may be considered to assess the model's efficiency and resource consumption.

To do so, the evaluation framework may determine one or more comparisons between online and offline ML models to validate the performance of the online model over time. First, an offline ML model may be trained and tested in a similar manner and/or using similar data to an online ML model identified for performance evaluation. This may be done using the same data streams, hyperparameters, datasets, and the like. The framework may execute operations to procedurally determine optimal training and testing batch sizes for the online ML model, which may be used to compute and calculate analytical metrics and other evaluation data for the online and offline models. This allows the value of OIL models to be proven and quantified. The framework may utilize the batch size to generate batch datasets that are run by (e.g., processed by) the online and offline ML models for performance evaluation, such as to measure performance based on one or more selected analytical metrics. Instead of batch sized datasets, the datasets may instead correspond to frames of data chunks, such as time-based frames of data streamed from a data stream.

Once batch datasets have been determined, an online run of the online ML model may be performed, such as using streaming or live data, which would mirror the standard or production environment operations of the online ML model. In this regard, each batch dataset may be used for online training, testing, and performance evaluation of the ML model. Similarly, the batch datasets, or other frames (e.g., time-frame windows or the like corresponding to data chunks received over a data stream), may be used for training and testing of the offline ML model, where similar performance and analytical metrics may result from outputs by such model after running on the batched dataset. A decay function for weights applied to the scores or values for the tested analytical metric may then be determined, where the decayed weights are applied to the online ML model's scores for that metric. Thereafter, a comparison may be made for purposes of the performance evaluation, which may include calculating a weighted average of a performance function output of the online ML model over a time period associated with the batch datasets. This may allow for identification of performance, and differences in performance, of the online ML model in a quantifiable manner based on the empirical measures.

As such, the embodiments described herein provide methods, computer program products, and computer database systems for an ML system for programmatically evaluating performance of online ML models, which may then be used for identifying and measuring the value of OIL models. A financial institution or other service provider system may therefore include a fraud detection system that may access different transaction datasets and detect fraud using online ML models after verifying the accuracy and performance of such models and implementing those models in a production environment. Thus, the evaluation framework may provide institutions and researchers with a powerful tool for effectively evaluating, comparing, and deploying online ML models. Once the model is deployed in production, ongoing comparisons with offline models are no longer necessary, as the proven value of the OIL model remains consistent, which allows for more accurate and reliable ML engines and systems. This provides a comprehensive and systematic approach to assess the performance of online ML models, thereby providing informed decision-making regarding deployment and ensuring adherence to SLAs.

According to some embodiments, in an ML system accessible by a plurality of separate and distinct organizations, ML algorithms, features, and models are provided for identifying, generating, and providing performance evaluations of online ML models in a programmatic manner through an evaluation framework and offline ML models, thereby providing faster, more efficient, and more precise ML model evaluation and deployment in online ML model systems.

### Example Environment

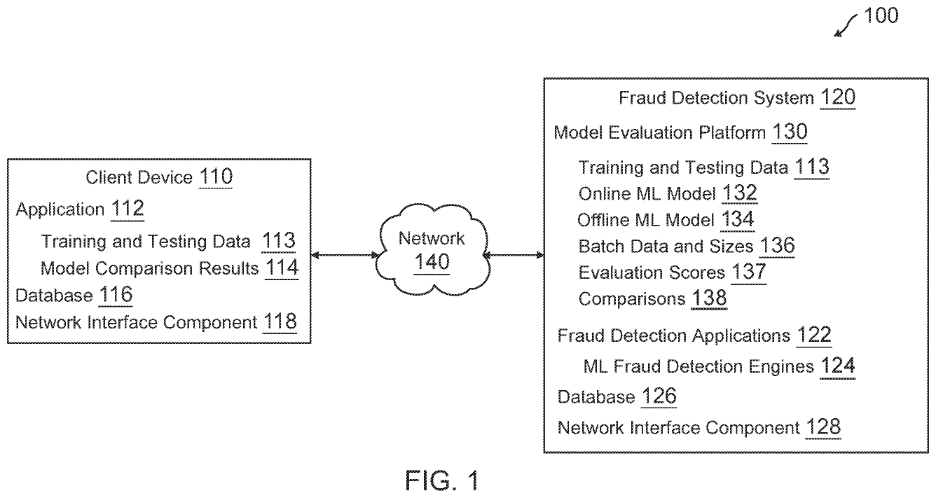

The system and methods of the present disclosure can include, incorporate, or operate in conjunction with, or in the environment of, an ML engine, model, and intelligent system, which may include an ML or other AI computing architecture that provides an automated and programmatic online ML model evaluation system for ML model performance and other analytical measures and metrics of ML model outputs. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML models, NNs, and other AI architectures have been developed to improve predictive analysis and classifications by systems in a manner similar to human decision-making, which increases efficiency and speed in performing predictive analysis on datasets requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and a fraud detection system 120 that interact over a network 140 to provide intelligent detection and/or prevention of fraud, or other ML task, through one or more online ML models and online model performance evaluation operations discussed herein. In other embodiments, environment 100 may not have all of the components listed and/or may have other elements instead of, or in addition to, those listed above. In some embodiments, environment 100 is an environment in which online ML model evaluation may be performed through an ML or other AI evaluation framework and system. As illustrated in FIG. 1, fraud detection system 120 might interact via a network 140 with client device 110 to generate, provide, and output analytical metrics and performance evaluations of online ML models.

For example, in fraud detection system 120, fraud detection applications 122 may process data and return a predictive score from an ML model, such as one utilized by ML fraud detection engines 124 to intelligently detect fraud using online ML models. ML fraud detection engines 124 may use online ML models that are trained and tested, as well as evaluated for performance prior to production environment implementation and release, using model evaluation platform 130. For example, online ML models may provide continuous learning and adaptation to new and changing datasets, such as emerging trends. However, performance evaluation of such models is difficult and, in current conventional implementations, impossible to quantify. As such, model evaluation platform 130 may provide an evaluation framework and operations to evaluate such online models' performance on training and testing data 113. Training and testing data 113 may be selected and/or identified for use from a data stream, repository, or the like by client device 110, for example, by a data scientist, ML modeler, or the like, utilizing application 112. The evaluation framework may provide improvements that may be realized through ML-based systems of model evaluation platform 130, which provide enhanced performance evaluation capabilities for ML models implemented in ML fraud detection engines 124.

Fraud detection system 120 may be utilized to provide fraud detection or other ML operations and systems to tenants, customers, and other users or entities, which may be based on online ML models evaluated using the evaluation framework discussed herein. Client device 110 may include an application 112 that provides training and testing data 113 for ML modeling and performance evaluation and receives model comparison results 114 having such performance evaluations. Fraud detection system 120 includes a model evaluation platform 130 for programmatic rule generation using ML operations. Fraud detection system 120 further includes fraud detection applications 122 to provide fraud detection services, which may include and/or be utilized in conjunction with computing services provided to customers, tenants, and other users or entities accessing and utilizing fraud detection system 120. In this regard, fraud detection applications 122 may include ML fraud detection engines 124 that implement online ML models that are reviewed and implemented using performance evaluations discussed herein. However, in other embodiments, such performance evaluations provided via model comparison results 114 may be utilized with other ML systems and models, such as those managed by separate computing systems, servers, and/or devices (e.g., tenant-specific, or controlled servers and/or server systems that may be separate from the performance evaluation systems discussed herein).

For online and offline ML models (e.g., decision trees and corresponding branches, NNs, clustering operations, etc.), the models trained from training and testing data 113, which may correspond to streaming data used to provide a basis for training each corresponding ML model. Model training and configuring may include performing feature engineering and/or selection of features or variables used by ML models, identifying data for features or variables in training and testing data 113, and/or using one or more ML algorithms, operations, or the like for modeling (e.g., including configuring decision trees or neural networks, weights, activation functions, input/hidden/output layers, and the like). Thus, one or more ML models, NNs, or other AI-based models and/or engines may be trained for fraud detection or another ML task. For example, when training online models, streaming data may be used. The training data may be labeled or unlabeled for different supervised or unsupervised ML and NN training algorithms, techniques, and/or systems. Fraud detection system 120 may further use features from such data for training, where the system may perform feature engineering and/or selection of features used for training and decision-making by one or more ML, NN, or other AI algorithms, operations, or the like (e.g., including configuring decision trees, weights, activation functions, input/hidden/output layers, and the like). After initial training. ML and other AI models and engines may be deployed in a production computing environment to receive inquires and data for features and predict labels or other classifiers from the data (e.g., fraud detection). An ML model may then be trained using a function and/or algorithm for the model trainer, as well as other ML systems, trainers, and operations for model and/or engine training and development. The training may include adjustment of weights, activation functions, node values, and the like.

After initial training of ML models using supervised or unsupervised ML algorithms (or combinations thereof), ML models may be evaluated for release and usage in a production computing environment to predict alerts, execute actions, classify data, or otherwise provide fraud detection for instances and/or occurrences of particular data (e.g., input transaction data indicating fraud or not). Online ML model 132 may be initially trained and/or configured for training as training and testing data 113 is streamed and/or provided for continuous and online training, which may further be evaluated for performance during this training and testing. In this regard, to evaluate a model that is constantly changing and learning, an offline ML model 134 may be configured, trained, and tested, which may serve as a base or benchmark to compare metrics for evaluating performance of the online ML model 132.

Offline ML model 134 may be trained in the same or similar manner and utilize the same or similar data, hyperparameters, streamed data, etc., as online ML model 132; however, since offline ML model 134 is offline and not continuously trained and/or static, offline ML model 134 may be trained in one batch. As such, offline ML model 134 may be considered a sibling or child ML model that mirrors or mimics online ML model 132, e.g., at a given point in time, when trained over the selected batch or frame. During training and testing, performance evaluations may be made to determine scores, values, or the like for analytical metrics, which may be based on batches of training and testing data 113. Batch data size may be determined algorithmically based on a predefined run of the offline and online learning on training and testing data 113 as a whole, a batch space of static size data, a number of predefined batches, and a performance function. Batch data and sizes 136 may result from this computation, which may be used to create batch dataset for evaluation purposes and determination of analytical metrics from online ML models 132 and offline ML models 134.

Model evaluation platform 130 may evaluate online ML model 132 and offline ML model 134 using batch data and sizes 136 (the unlabeled batched dataset(s)) from training and testing data 113 by determining evaluation scores 137, such as corresponding F1 scores (e.g., a harmonic means of precision and recall, which may correspond to an ML metric for classification models). F1 scores may be calculated using the precision, such as the ratio of true positives to all positives (e.g., true and false positives), and recall, such as the ratio of true positives to all true positives and false negatives. In other embodiments, other metrics for evaluation scores 137 may be determined, such as a receiver operating characteristic area under a curve (ROC AUC), a model accuracy, a model recall, or a model precision. Using evaluation scores 137, comparisons 138 may be made between online ML model 132 and offline ML model 134. Comparisons 138 may be based on analytical metrics having evaluation scores 137, which may also be weighted by applying a decay function to the weights for the performance scores of online ML model 132. Comparisons 138 may identify the accuracy, resource usage, and other performance of online ML model 132, which may be used to determine if such performance is within, meets, or exceeds acceptable standards and requirements to release online ML model 132 and utilize such model in a production environment. As such, determination of evaluation scores 137 and comparisons 138 may occur prior to release and during training and testing in order to determine if online ML model 132 is in an acceptable performance form for release.

One or more client devices and/or servers (e.g., client device 110 using application 112) may execute a web-based client that accesses a web-based application for fraud detection system 120, or may utilize a rich client, such as a dedicated resident application, to access fraud detection system 120, which may be provided by fraud detection applications 122 to such client devices and/or servers. Client device 110 and/or other devices or servers may utilize one or more application programming interfaces (APIs) to access and interface with fraud detection applications 122 and/or ML fraud detection engines 124 of fraud detection system 120 in order to schedule, review, and execute ML modeling and performance evaluation using the operations discussed herein. Interfacing with fraud detection system 120 may be provided through fraud detection applications 122 and/or ML fraud detection engines 124 and may be based on data stored by database 126 of fraud detection system 120 and/or database 116 of client device 110. Client device 110 and/or other devices and servers on network 140 might communicate with fraud detection system 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and fraud detection system 120 may occur over network 140 using a network interface component 118 of client device 110 and a network interface component 128 of fraud detection system 120. In an example where HTTP/HTTPS is used, client device 110 might include an HTTP/HTTPS client for application 112, commonly referred to as a “browser,” for sending and receiving HTTP/HTTPS messages to and from an HTTP/HTTPS server, such as fraud detection system 120 via the network interface component.

Similarly, fraud detection system 120 may host an online platform accessible over network 140 that communicates information to and receives information from client device 110. Such an HTTP/HTTPS server might be implemented as the sole network interface between client device 110 and fraud detection system 120, but other techniques might be used as well or instead. In some implementations, the interface between client device 110 and fraud detection system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with fraud detection system 120 and/or other devices and servers, and vice versa, which is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol. Further, one or more of client device 110 and/or fraud detection system 120 may be included by the same system, server, and/or device and therefore communicate directly or over an internal network.

According to one embodiment, fraud detection system 120 is configured to provide webpages, forms, applications, data, and media content to one or more client devices and/or to receive data from client device 110 and/or other devices, servers, and online resources. In some embodiments, fraud detection system 120 may be provided or implemented in a cloud environment, which may be accessible through one or more APIs with or without a corresponding graphical user interface (GUI) output. Fraud detection system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data used for ML fraud detection engines 124 of fraud detection system 120 during use of fraud detection applications 122, as well as evaluating performance of online ML models (e.g., online ML model 132 and the like) using model evaluation platform 130. In some embodiments, this may include providing training and testing data 113 based on datasets to be processed for model training and testing, with further evaluating of performance. In one embodiment, client device 110 includes application servers configured to implement and execute software applications as well as provide related data, code, forms, webpages, platform components or restrictions, and other information associated with datasets for ML models, and to store to, and retrieve from, a database system related data, objects, and web page content associated with datasets for ML models. For example, fraud detection system 120 may implement various functions of processing logic and processing components, and the processing space for executing system processes, such as running applications for ML modeling. Client device 110 and fraud detection system 120 may be accessible over network 140. Thus, fraud detection system 120 may send and receive data to client device 110 via network interface component 128. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients.

Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to fraud detection system 120 that provides one or more APIs for interaction with client device 110 in order to submit datasets, select datasets, and perform modeling and evaluating operations for an ML system configured for fraud detection.

Thus, client device 110 and/or fraud detection system 120 and all of their components might be operator configurable using application(s) including computer code to run using a central processing unit, which may include an Intel Pentium® processor or the like, and/or multiple processor units. A server for client device 110 and/or fraud detection system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and fraud detection system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Evaluation Framework and Online ML Model Performance Evaluation

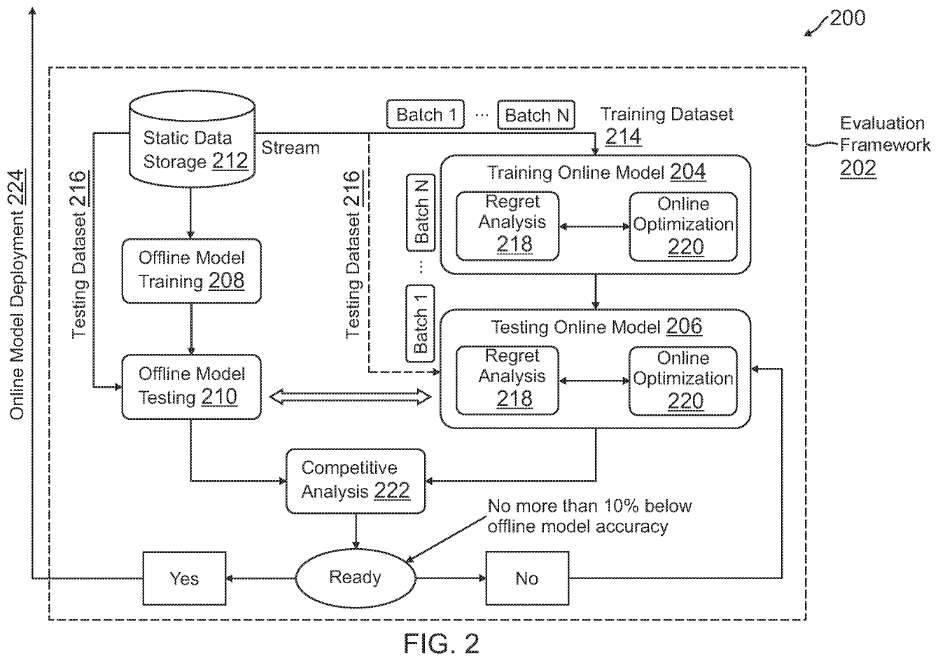

FIG. 2 is a simplified diagram of a computing architecture 200 to programmatically evaluate the performance of online ML models using sibling offline ML models trained and tested using batch datasets according to some embodiments. Computing architecture 200 of FIG. 2 includes an evaluation framework 202 and data processing flow for ML operations that perform a performance evaluation of online ML models, such as the operations and components of fraud detection system 120 when using model evaluation platform 130 discussed in reference to environment 100 of FIG. 1. In this regard, computing architecture 200 displays evaluation framework 202 and a processing infrastructure utilized by an ML or other AI system for evaluating online ML models prior to release in a production computing environment, such as with ML fraud detection engines 124 of fraud detection applications 122 from environment 100. Thus, the processes in computing architecture 200 may be utilized to conduct performance evaluations using an offline ML model acting as a copy, sibling, or similarly trained ML model to an online ML model.

An ML model and/or rules for fraud detection may be trained and created using one or more ML algorithms and historical training data to provide intelligent outputs, such as classifications, decision-making, predictions and the like in an automated manner without user input or intelligence. These models attempt to mimic human thinking by learning from the past historical training data to make correlations, predictions, and interpretations based on pattern analysis and the like. ML models may correspond to different types or classifications of models, such as NNs, tree-based models, clustering models, etc. For example, with decision trees, a tree model may be used where each decision path from the “root” of the tree to a “leaf” may serve as a rule. The rule's maximum complexity may be given by the tree's maximum depth. With neural networks, layers may be trained having nodes with activation functions and weights that are interconnected between layers to resemble neurons and mimic human thinking through feed forward and/or backwards propagation networks.

For ML-driven model training and testing prior to utilization in a production environment, performance evaluation may be performed to identify performance of the model by different analytical metrics for accuracy, required processing resources (e.g., CPU/GPU usage, etc.), memory usage, false positive ratio, and the like. In this regard, different analytical metrics may include an F1 score, an ROC AUC, a model accuracy, a model recall, a model precision, or the like. With evaluation framework 202 for performance evaluation of an online model, an online model training 204 and an online model testing 206 may be analyzed and evaluated for performance using an offline model training 208 and an offline model testing 210. A static data storage 212 may be used to provide a training dataset 214 and a testing dataset 216, which may correspond to separate datasets that may be used during a training, and thereafter a testing, phase of modeling for the online and offline models.

Training dataset 214 and testing dataset 216 may correspond to transactions in a transaction data stream and/or channel, which may be evaluated for anomalies during model training. Such transactions may be associated with fraud (e.g., the anomalies) and may include labeled and unlabeled data. For example, training dataset 214 may include fraud labels while testing dataset 216 and/or another dataset that may be used for performance evaluation may be unlabeled. In other embodiments, different data may be used for corresponding ML tasks.

During training, features considered for model training may be determined, such as those features available to an ML platform's decision processes at a time of execution (e.g., available to an ML model trainer and/or decision platform of a service provider). This may include a variety of features describing the transaction or other data for the ML task designated for model training. Feature engineering may be performed using domain knowledge to extract features from raw data (e.g., variables) in training dataset 214 and/or testing dataset 216. Data preparation may further occur by performing data cleaning, under sampling, and feature engineering. Additionally, model hyperparameters may be established and optimized, and thereafter to generate training dataset 214 and testing dataset 216, data splitting (e.g., into test, validation, and evaluating time-consecutive groups).

Using training dataset 214 and testing dataset 216, a run may be performed that may include batched datasets used for evaluation purposes based on one or more analytical metrics selected for and/or of interest to determining model performance. As such, for the online model, online model training 204 and online model testing may be performed, and for the offline model, offline model training and offline model testing 210 may be performed, each based on batched datasets from training dataset 214 and testing dataset 216. Batch size for the batch datasets may be algorithmically determined and computed by evaluation framework 202

When training, different ML operations and algorithms may be used. For example, decision trees may include different branches and layers to each branch, such as an input layer, one or more branches with computational nodes for decisions that branch or spread out, and an output layer, each having one or more nodes. Similarly, NNs may use nodes linked in different layers to form neurons that may include input, hidden, and output layers. ML models with multiple layers, including an input layer, one or more hidden layers, and an output layer having one or more nodes, may be used. Each node within a layer is connected to a node within an adjacent layer, where a set of input values may be used to generate one or more output values or classifications. Within the input layer, each node may correspond to a distinct attribute or input data type associated with features for input data.

Thereafter, the internal, interceding, or hidden layers and/or nodes may be generated with these attributes and corresponding weights using an ML or deep learning algorithm, computation, and/or technique. For example, each of the nodes in the hidden or internal layers generates a representation, which may include a mathematical ML or NN computation (or algorithm) that produces a value based on the input values of the input nodes. The algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values that provide a classification, prediction, or the like. Thus, when the ML or NN model is used to perform a predictive analysis, classification, or the like, the input may provide a corresponding output based on the trained classifications. With a NN, by providing input data when training the NN, the nodes in the layers may be adjusted such that an optimal output (e.g., a classification) is produced in the output layer. By continuously providing different sets of data and penalizing the NN when the output of the NN is incorrect, the NN (and specifically, the representations of the nodes in the layers, branches, neurons, or the like) may be adjusted to improve its performance in data classification.

During online model training and online model testing, a regret analysis 218 and an online optimization 220 may be performed by evaluation framework 202 for a competitive analysis 222, such as based on performance of the online model. In some embodiments, these outputs may be compared to the performance of the offline model computed over the batch dataset for offline model training 208 and offline model testing 210 (e.g., where the offline model is trained and tested in a single batch as the model is static and a single frame or batch may be used, however, additional batches may also be utilized). Regret analysis 218 may measure current model performance during online model training 204 and/or online model testing 206 to a last best model performance. Online optimization 220 may further perform operations to adjust and configure the online ML model during training and/or testing for better model performance. Outputs of online model testing 206, such as based on testing dataset 216, may include scores and the like for model performance computed using the selected analytical metrics over the batched datasets. Such data may then be provided to competitive analysis 222 for comparison to scores computed for the offline model during offline model training 208 and/or offline model testing 210.

From competitive analysis 222, it may be determined whether the online model is ready for deployment. For example, a threshold accuracy of the model may be required when compared to the offline model, and the online model may be required to be no more than 10% (or other threshold) below the accuracy of the offline model. Thus, the scores may be compared, where a decayed weight may be applied to the online model's scores to account for over-time or time-based changes and decay of the model as the dataset moves over the time frame and is further trained. If the model has not met or exceeded the threshold or other requirement for model performance, model training and testing may further occur with the online model. However, if so, and if the ML model meets the requirements, standards, thresholds, of the like for production deployment, then an online model deployment 224 of the online ML model may be performed.

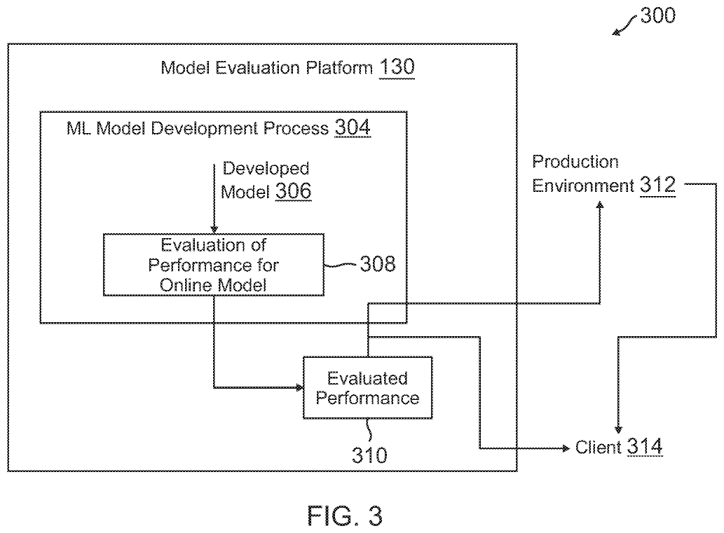

FIG. 3 is a simplified diagram of a computing architecture 300 including an ML modeling platform that may implement an online ML model through a development process that evaluates performance using a sibling offline ML model according to some embodiments. In computing architecture 300, model evaluation platform 130 may interact with a production environment 312 and a client 314 to train, test, and evaluate an online ML model prior to release and use with an ML engine and/or system. In this regard, model evaluation platform 130 may be executed by and/or in a server, system, cloud computing environment, or the like for an ML modeling and/or intelligent decision-making platform, such as one used for fraud detection or another ML task.

ML model development process 304 may performing training, testing, and evaluating for an online ML model, where the online ML model may be incrementally and/or continuously trained using streaming data, such as data that may be streamed from a production environment and/or live data being used and/or consumed by live data processing systems of a service provider, fraud detection system, or the like. ML model development process 304 may include operations, ML algorithms, datasets, and the like to perform online model training, such as for an OIL model. Developed model 306 may result, which may then be evaluated for performance through an evaluation 308.

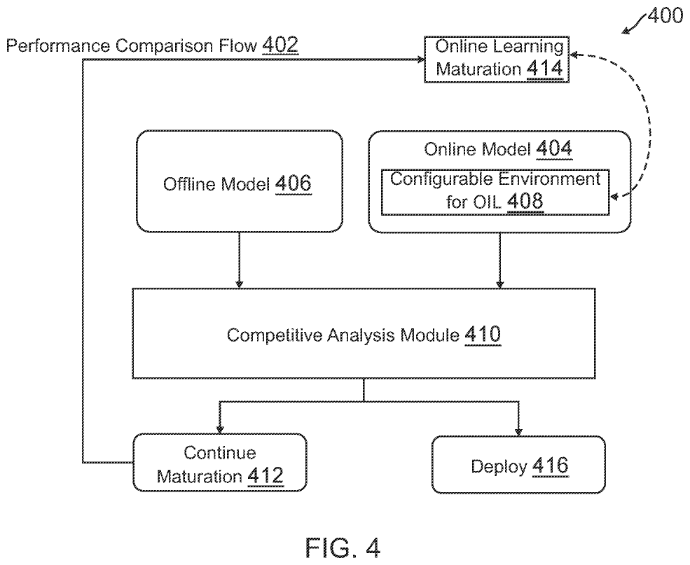

Evaluation 308 may correspond to a process to evaluate developed model 306 through comparisons of scores and other measures for one or more analytical metrics calculated for developed model 306 and the corresponding offline ML model. Evaluation 308 may utilize one or more batched datasets based on a batch size computed for developed model 306. These datasets may be used during an online run to determine the corresponding performance metric during the training, testing, and evaluating (e.g., during OIL of the model). The offline model may be trained and tested using the same data, and as such, one or more scores for the performance metric may similarly be calculated with the offline model when trained and tested on the selected batched dataset. Using the scores and decayed weights applied to the scores for developed model 306, evaluation 308 may be performed through score comparisons, as well as threshold score differences. Evaluation 308 of performance for developed model 306 using an algorithmic flow and processing operations are discussed in further detail with regard to FIG. 4 below.

Output of evaluation 308 may include an evaluated performance 310, which may then be used with production environment 312 and client 314. For example, evaluated performance 310 may be used to provide actionable insights and monitoring/evaluating of developed model 306 prior to release in production environment 312. Output of evaluated performance 310 may be provided on client 314 so that a decision on model release in production environment 312 may be made. For example, client 314 may review performance differences, such as in accuracy, resources used, false positive rate, detection or alert rate, etc., and may choose to further train and configure developed model 306 or release developed model 306 in production environment 312 for decision-making, predictions, or other intelligent outputs. However, such operations may also be automated once evaluated performance 310 meets or exceeds certain conditions, requirements, thresholds, or the like. Production environment 312 may then allow for use of developed model 306 once trained, verified, and validated for adherence to requirements for use.

FIG. 4 is a simplified diagram 400 of ML operations used for performance evaluations of online ML models using comparisons of metrics and analytics with sibling offline ML models according to some embodiments. Diagram 400 of FIG. 4 includes ML operations that programmatically perform performance evaluations of online ML models, such as those evaluations performed by fraud detection system 120 using model evaluation platform 130 discussed in reference to environment 100 of FIG. 1. In this regard, diagram 400 displays a performance comparison flow 402 that may be performed by evaluation framework 202 from computing architecture 200 of FIG. 2.

In diagram 400, an online model 404 may be trained and tested in a configurable environment, which may be replicated for an offline model 406 for training and testing, such as to generate a sibling offline ML model for performance evaluation purposes. Online model 404 may be trained using OIL 408 with streaming data, such as a data stream designated for incremental, online, and/or continuous learning from one or more streamed data sources, such as live production data from a production computing environment and/or a subset of available data from such environment or other data source. A competitive analysis module 410 may then be executed in order to evaluate performance of online model 404 using offline model 406 as a benchmark or baseline for analysis of analytical metrics used to score or track performance. As such, online model 404 and offline model 406 may be accessed by competitive analysis model 410 and a run of both for training, testing, and/or evaluating may be performed.

In order to evaluate performance of online model 404, competitive analysis module 410 may utilize a dataset to determine a batch data size, perform batching operations on the dataset, and run those batches with online model 404 and offline model 406 for a performance evaluation. An exemplary algorithmic formula and flow for performance evaluation of online model 404 using offline model 406 by competitive analysis module 410 may be performed using the following Equations 1:

### Equations 1

Perform training and testing of an offline sibling ML model and algorithm on a dataset D where Dₜᵣₐᵢₙ and Dₜₑₛₜ is training and testing data, respectively, calculating F1 score for M-offline model, M-online model;

Find an optimal batch size based on a pre-defined run between offline and online learning on the dataset D as a whole using:

$${batch}_{size} = {{arg}_{min}}_{b ∈ {B}^{s}} \{ {P}^{offline} ( {D}_{train} ) - {P}^{online} ( D ; \vert b \vert ) \}$$

where B^{s} is the batch space of static size data for D, |b| is the number of predefined batches, and P is a performance function;

Calculate incrementally the average value of the F1 score during the online run of the online ML model over D:

$${m}_{n} = \frac{( n - 1 ) {m}_{n - 1} + {a}_{n}}{n}$$

$${m}_{n} = {m}_{n - 1} + \frac{{a}_{n} - {m}_{n - 1}}{n}$$

where mₙ is F1-score at any given moment n;

Calculate a decay function of weights τ for each incremental measurement of the F1 score for the online model M^{(t)}_{(F1-score)};

$$τ ( t ) = {τ}_{0} {e}^{- \frac{t}{τ}}$$

Compare M_{(F1-score)}==M^{(t)}_{(F1-score)} at any given time t, with each M^{(t)}_{(F1-score)} assigned its corresponding decayed weight from the decay function of the weights;

Calculate the weighted average per P(M) over the time period considering the exponential decay:

$$\frac{1}{N} {\sum }_{t = 0}^{N} τ ( T ) \cdot {\hat{M}}_{F 1 - score}^{( t )}$$

As such, ML models and algorithms may be evaluated for their performance and a resulting comparison, one or more scores, a measurement or ratio, and the like may be determined. Other measurements or ratio may include a competitive ratio for a minimum score ratio between scores online model 404 and offline model 406 or a ratio for a minimal one of such scores. When analyzing and evaluating the performance, hyperparameters for training and evaluating of online model 404, as well as offline model 406 in some embodiments, may be configured, adjusted, and set. The hyperparameters may be used with OIL 408 during evaluating for calculation of scores for an analytical metric. Such hyperparameters may include a preset batch size, a time frame size, a moving average window size, weights for moving averages, the preset weights, or a training data size of the training dataset. The evaluation by competitive analysis module 410 may be performed over time, such as the time frame for the dataset, and measured by different metrics (e.g., F1, ROC AUC, accuracy, recall, precision, etc.). These metrics may be tracked per batch, where the score may be calculated for each batch, the moving (weighted average of the last X batches), and/or for all previously seen batches (e.g., an accumulated score), as well as on a per fixed-size sample of the frame (e.g., the time frame for the dataset). With a per fixed-size sample of the frame, the score may be calculated for each sample frame, the moving (weighted) average of the last X frames, and/or for all previously seen frames (e.g., accumulated score). In some embodiments, the fixed frame may be selected to allow comparison between models trained with different batch sizes by instead comparing the same data chunk.

Thereafter, an output may be provided by competitive analysis module 410 for model comparison of scores of analytical metrics of online model 404 and offline model 406. Evaluation framework 202, by executing performance comparison flow 402, may provide, graphically or the like, each of the metrics or measures as a function of the number of samples seen during the training or testing/evaluation, as well as statistics of each metrics (e.g., mean, standard deviation, median, minimum/maximum values, etc.). Additionally, dedicated performance measures may be calculated, such as a competitive ratio (e.g., given all possible input sequences, consider the worst-case input, which maximizes the ratio of the cost or loss of online model 404 for that input, for comparison to the cost of offline model 406 on that same input) and/or a max-max ratio (e.g., the ratio between the minimal online model metric score and the minimal offline model score for all the batches seen during the evaluation), as well as hardware and software performances (e.g., CPU/GPU usage, memory consumption, run time, etc.).

Competitive analysis module 410 may determine, or may provide a score or other output data to allow a user to determine, whether to continue maturation 412 of online model 404 or deploy 416, in a production environment, the trained and evaluated model. If continue maturation 412 is selected or determined, such as if the performance of online model 404 is insufficient to meet requirements or standards, performance comparison flow 402 may proceed to online learning maturation with OIL 408 to further train and test online model 404, such as using further streaming data. However, if approved for release, deploy 416 may proceed to release online model 404 from the training and testing computing environment to a production computing environment.

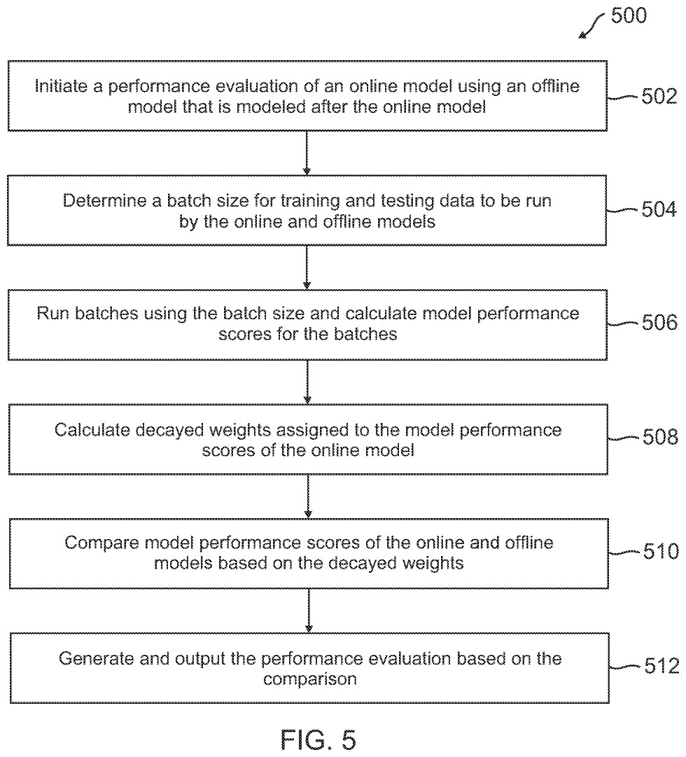

FIG. 5 is a simplified diagram of an exemplary flowchart 500 for determining and providing a performance evaluation of an online ML model using an evaluation framework with an offline ML model according to some embodiments. Note that one or more steps, processes, and methods described herein of flowchart 500 may be omitted, performed in a different sequence, or combined as desired or appropriate based on the guidance provided herein. Flowchart 500 of FIG. 5 includes operations for evaluating performance of online ML models using an evaluation framework that utilizes sibling offline ML models, as discussed in reference to FIG. 1-4. One or more of steps 502-512 of flowchart 500 may be implemented, at least in part, in the form of executable code stored on non-transitory, tangible, machine-readable media that when run by one or more processors may cause the one or more processors to perform one or more of steps 502-512. In some embodiments, flowchart 500 can be performed by one or more computing devices discussed in environment 100 of FIG. 1.

At step 502 of flowchart 500, a performance evaluation of an online model is initiated using an offline model that has been trained in a similar manner to the online model. The online model may correspond to an OIL ML model, which may perform incremental and/or continuous learning on incoming data and/or streaming data from real-time, online, and/or production data and processing requests. In this regard, the model may be continually learning, which, in existing conventional systems, makes assessing model performance on past dataset and/or over time difficult if not impossible as the model is dynamically adapting and learning from streaming data in real-time. Instead, as discussed herein, an evaluation framework may allow for comparisons of the online model to the offline model as a performance benchmark, against which, effectiveness of the online model may be validated. The offline model may therefore be trained in the same or similar manner and using the same or similar streaming data from a batch of training and testing data that may be used with the online model. For the offline model, a single batch size and batch training may be performed as the offline model may be static in nature and incrementally and/or continuously learning. The training and testing of the offline sibling model and algorithm may be performed on a dataset as a whole, and one or more scores for one or more analytical metrics may be determined for identification of performance of the offline model.

At step 504, a batch size for training and testing data that is to be run by or on the online and offline models is determined. The batch size may be determined as an optimal size given the predefined run to be made between the offline and online learning as a whole of the training and testing dataset. The optimal batch size may be determined algorithmically by a batch data operation or engine and may be based on a batch space of static size for the whole training and testing dataset, a number of predefined batches, and a performance function for the performance evaluation. For the online model, batches from the training and testing data may be determined based on the batch size, which may be segmented or portioned from the training and testing dataset as a whole. As such, the evaluation framework may perform batch size calculation and batch dataset determination for running with the online ML model.

At step 506, batches are run using the batch size and model performance scores are calculated for the batches. The batches may be run so that the online model is trained and tested, and performance is evaluated, over the online run of the batched datasets. The online run of the online model may be done for training and testing on the training and testing dataset as a whole, where the batched datasets are used to calculate and compute scores for analytical metrics or measures for the batched datasets. At step 508, decayed weights assigned to the model performance scores of the online model are calculated. The decayed weights are calculated using a decay function, which applies an incremental decay measurement, factor, coefficient, or other weight to the online model's scores from the online run using the training and testing dataset with batched datasets.

At step 510, model performance scores of the online and offline models are compared based on the decayed weights, which may be applied to the model performance scores of the online model. The model performance scores may be compared by comparing the output scores for the analytical metric at any given time from the online model and the offline model. However, each metric's score for the online model may be assigned and compared with its corresponding decay weight. At step 512, the performance evaluation is generated based on the comparison and output for further processing and/or use. The performance evaluation may correspond to a calculated weighted average per score over the time period considering the decay. One or more interfaces may be provided for users, teams, entities, or the like to review the performance evaluation for the online ML model corresponding to the ML classification task. Customers and tenants may then apply the online ML model when sufficiently accurate and/or meeting or exceeding performance requirements, such as to perform alert detection and generation systems implementing ML models and engines or another ML task.

As discussed above and further emphasized here, FIGS. 1, 2, 3, 4, and 5 are merely examples of fraud detection system 120 and corresponding methods for performance evaluation of online ML models using an evaluation framework, which said examples should not be used to unduly limit the scope of the claims. One of ordinary skill in the art would recognize many variations, alternatives, and modifications.

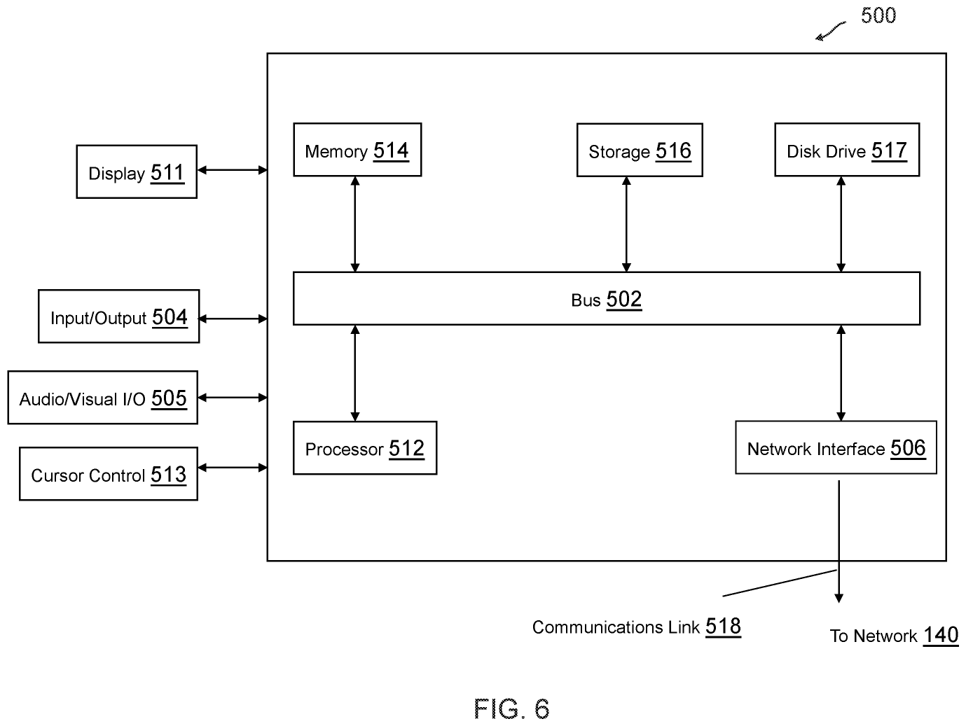

FIG. 6 is a block diagram of a computer system 600 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals. Audio/visual I/O component 605 may allow the user to hear audio, and well as input and/or output video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A machine learning (ML) system configured to provide a performance evaluation of an online ML model using an evaluation framework with an offline ML model, the ML system comprising:
a processor and a computer readable medium operably coupled thereto, the computer readable medium comprising a plurality of instructions stored in association therewith that are accessible to, and executable by, the processor, to perform model comparison operations which comprise:
accessing, for a performance evaluation of a first ML model, a second ML model to be tested for an analytical metric using the evaluation framework, wherein the second ML model is correlated with the first ML model and trained and tested on a dataset comprising a training dataset and a testing dataset;
determining a batch size for the performance evaluation of the first ML model using the dataset based on a pre-defined learning run of the first ML model and the second ML model on the dataset;
calculating first model scores for the analytical metric during an online run of the first ML model on the dataset over each batch generated from the dataset using the batch size;
calculating decayed weights applied to the first model scores using a decay function and preset weights for the evaluation framework;
comparing the first model scores with second model scores for the second ML model that are associated with each batch generated from the dataset using the batch size, wherein the comparing includes calculating a weighted average of a performance function output for the first ML model over a time period based on the first model scores, the second model scores, and the decayed weights; and
outputting the performance evaluation for the first ML model based on the comparing.

2. The ML system of claim 1, wherein the first ML model is an online ML model performing a continuous learning using streaming data, and wherein the second ML model is an offline sibling model of the online ML model configured to mimic the continuous learning of the online ML model.

3. The ML system of claim 1, wherein the analytical metric comprises an F1 score metric for a harmonic mean of a precision and an accuracy of a corresponding model.

4. The ML system of claim 1, wherein the performance evaluation is performed during a training and testing phase of the first ML model prior to a deployment in a production computing environment.

5. The ML system of claim 4, wherein the model comparison operations further comprise:
approving, based on the calculated weighted average of the performance function output meeting or exceeding a threshold comparison similarity, the first ML model for the deployment in the production computing environment.

6. The ML system of claim 1, wherein the evaluation framework includes user controls for hyperparameters for training and evaluating the first ML model, and wherein the hyperparameters comprise at least one of a preset batch size, a time frame size, a moving average window size, weights for moving average, the preset weights, or a training data size of the training dataset.

7. The ML system of claim 1, wherein the analytical metric is user selectable from a plurality of metrics including at least one of an F1 score, a receiver operating characteristic area under a curve (ROC AUC), a model accuracy, a model recall, or a model precision.

8. The ML system of claim 1, wherein the performance evaluation comprises a measurement of one of a competitive ratio for a minimum ratio between the first model scores and the second model scores or a ratio for a minimal one of the first model scores with the second model scores.

9. A method to provide a performance evaluation of an online machine learning (ML) model using an evaluation framework with an offline ML model for an ML system, the method comprising:
accessing, for a performance evaluation of a first ML model, a second ML model to be tested for an analytical metric using the evaluation framework, wherein the second ML model is correlated with the first ML model and trained and tested on a dataset comprising a training dataset and a testing dataset;
determining a batch size for the performance evaluation of the first ML model using the dataset based on a pre-defined learning run of the first ML model and the second ML model on the dataset;
calculating first model scores for the analytical metric during an online run of the first ML model on the dataset over each batch generated from the dataset using the batch size;
calculating decayed weights applied to the first model scores using a decay function and preset weights for the evaluation framework;
comparing the first model scores with second model scores for the second ML model that are associated with each batch generated from the dataset using the batch size, wherein the comparing includes calculating a weighted average of a performance function output for the first ML model over a time period based on the first model scores, the second model scores, and the decayed weights; and
outputting the performance evaluation for the first ML model based on the comparing.

10. The method of claim 9, wherein the first ML model is an online ML model performing a continuous learning using streaming data, and wherein the second ML model is an offline sibling model of the online ML model configured to mimic the continuous learning of the online ML model.

11. The method of claim 9, wherein the analytical metric comprises an F1 score metric for a harmonic mean of a precision and an accuracy of a corresponding model.

12. The method of claim 9, wherein the performance evaluation is performed during a training and testing phase of the first ML model prior to a deployment in a production computing environment.

13. The method of claim 9, further comprising:
approving, based on the calculated weighted average of the performance function output meeting or exceeding a threshold comparison similarity, the first ML model for the deployment in the production computing environment.

14. The method of claim 9, wherein the evaluation framework includes user controls for hyperparameters for training and evaluating the first ML model, and wherein the hyperparameters comprise at least one of a preset batch size, a time frame size, a moving average window size, weights for moving average, the preset weights, or a training data size of the training dataset.

15. The method of claim 9, wherein the analytical metric is user selectable from a plurality of metrics including at least one of an F1 score, a receiver operating characteristic area under a curve (ROC AUC), a model accuracy, a model recall, or a model precision.

16. The method of claim 9, wherein the performance evaluation comprises a measurement of one of a competitive ratio for a minimum ratio between the first model scores and the second model scores or a ratio for a minimal one of the first model scores with the second model scores.

17. A non-transitory computer-readable medium having stored thereon computer-readable instructions executable to provide a performance evaluation of an online machine learning (ML) model using an evaluation framework with an offline ML model for an ML system, the computer-readable instructions executable to perform model comparison operations which comprise:
accessing, for a performance evaluation of a first ML model, a second ML model to be tested for an analytical metric using the evaluation framework, wherein the second ML model is correlated with the first ML model and trained and tested on a dataset comprising a training dataset and a testing dataset;
determining a batch size for the performance evaluation of the first ML model using the dataset based on a pre-defined learning run of the first ML model and the second ML model on the dataset;
calculating first model scores for the analytical metric during an online run of the first ML model on the dataset over each batch generated from the dataset using the batch size;
calculating decayed weights applied to the first model scores using a decay function and preset weights for the evaluation framework;
comparing the first model scores with second model scores for the second ML model that are associated with each batch generated from the dataset using the batch size, wherein the comparing includes calculating a weighted average of a performance function output for the first ML model over a time period based on the first model scores, the second model scores, and the decayed weights; and
outputting the performance evaluation for the first ML model based on the comparing.

18. The non-transitory computer-readable medium of claim 17, wherein the first ML model is an online ML model performing a continuous learning using streaming data, and wherein the second ML model is an offline sibling model of the online ML model configured to mimic the continuous learning of the online ML model.

19. The non-transitory computer-readable medium of claim 17, wherein the analytical metric comprises an F1 score metric for a harmonic mean of a precision and an accuracy of a corresponding model.

20. The non-transitory computer-readable medium of claim 17, wherein the performance evaluation is performed during a training and testing phase of the first ML model prior to a deployment in a production computing environment.
